(19) United States
(12) Patent Application Publication
(10) Pub. No.: US 2003/0011963 A1
(43) Pub. Date: Jan. 16, 2003

(54) Multiterminal multilayer ceramic electronic device

(75) Inventors: Taisuke Ahiko, Akita-ken (JP); Sunao Masuda, Tokyo (JP); Masaaki Togashi, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/191,568

(22) Filed: Jul. 10, 2002

(30) Foreign Application Priority Data
Jul. 16, 2001 (JP) 2001-215145

(51) Int. Cl. H01G 4/06

(52) U.S. Cl. 361/321.2

(57) ABSTRACT

A multiterminal multilayer ceramic electronic device comprising a capacitor body formed by stacking dielectric layers, a plurality of internal electrodes separated by dielectric layers inside the capacitor body, each having at least one lead led out toward any side face of the capacitor body, and differing in position of arrangement of the lead with the nearby internal electrodes, and a plurality of terminal electrodes arranged at the outside surface of the capacitor body and connected to any of the plurality of internal electrodes through the leads. Between the internal electrodes not formed a lead and the terminal electrodes are formed a compensation layers. The compensation layers have approximately the same thickness as that of the internal electrodes, being not connected to at least one of the internal electrodes and the terminal electrodes, and separated from each other on an identical plane.

### BACKGROUND OF THE INVENTION

1. Field of the Invention

The present invention relates to a multiterminal multilayer ceramic electronic device, a part main body of which is a multilayer ceramic body formed by providing an internal electrode including lead electrode for leading from the internal electrode in the width direction of the part main body on a plane of a ceramic green sheet and alternately stacking a plurality of the ceramic sheets and the internal electrodes.

2. Description of the Related Art

As a multiterminal multilayer ceramic capacitor, a capacitor described below is known. Namely, an eight-terminal multilayer capacitor wherein a group of ceramic green sheets (not shown) respectively provided with lead electrodes 2a to 2d for respectively leading from different positions of internal electrodes 1a to 1d (shown in FIG. 9) in the width direction Y and a group of ceramic green sheets (not shown) respectively provided with lead electrodes 2a′ to 2d′ for leading from different positions of internal electrodes 1a′ to 1d′ (shown in FIG. 10) are stacked is known.

In the multilayer ceramic capacitor, a thickness in the stacking direction decreases (hereinafter, also referred to as collapse/sag) in a part not being formed a lead electrode (lead) comparing with that in a part being formed a lead electrode on both sides in the width direction Y. Therefore, along with pressure adhering performed after stacking the ceramic green sheets, the ceramic layer collapses/sags on both sides in the width direction and the lead electrode deforms. As a result, burning processing of the multilayer ceramic body leads to a structural default caused by cracks and an air gap of the ceramic layer or a break of a lead electrode, etc.

To prevent the collapse/sag of the ceramic layer, in a two-terminal multilayer ceramic capacitor provided with external electrodes on both ends of a multilayer ceramic body, provision of a compensation layer (dummy electrode) made by a conductive paste of a same material as an internal electrode by separating it on both side portions of the internal electrode has been proposed (The Japanese Unexamined utility model No. 3-59627).

When applying the compensation layer, the collapse/sag of the ceramic layer can be prevented. However, since the compensation layer has a band shape over approximately all length of the multilayer ceramic body in the longitudinal direction, an adhesion area between ceramic green sheets becomes small. Consequently, the ceramic green sheets cannot be sufficiently adhered even by performing pressure adhering processing after stacking them and it is liable that separation between layers occurs.

### SUMMARY OF THE INVENTION

An object of the present invention is to provide a multiterminal multilayer ceramic electronic device capable of preventing collapse/sag of ceramic layers by being provided with a compensation layer and sufficiently keeping adhesion strength between the ceramic layers.

To achieve the object, a first multilayer electronic device of the present invention is comprised of a ceramic body formed by stacking dielectric layers; a plurality of internal electrodes separated by dielectric layers inside the ceramic body, each having at least one lead led out toward any side face of the ceramic body, and differing in position of arrangement of the leads with the nearby internal electrodes; and a plurality of terminal electrodes arranged at the outside surface of the ceramic body and connected to any of the plurality of the internal electrodes through the leads; and a compensation layer formed between the internal electrodes from which the leads are not formed and the terminal electrodes, having approximately the same thickness as that of the internal electrodes, not connected to at least one of the internal electrodes and the terminal electrodes, and separated from each other on the same plane.

According to the present invention, a compensation layer is formed between the internal electrode and the terminal electrode not being formed the lead. Therefore, collapse/sag of a dielectric layer of the ceramic body can be efficiently prevented on a lead forming side of the internal electrode after pressure adhering performed after stacking the ceramic green sheets (a portion to be the dielectric layer). Also, since the compensation layer is separated from each other on an identical plane, dielectric layers sandwiching the internal electrode firmly adhere to each other and an adhesion area of the dielectric layers can be sufficiently secured. As a result, an occurrence of cracks and air gaps of the dielectric layers can be suppressed and breaks of leads (lead electrodes) can be prevented. Furthermore, an occurrence of structural defaults due to bad adhesion of the dielectric layers can be prevented and the productivity yield can be improved.

Preferably, the compensation layer is comprised of the same material as that of the internal electrodes and formed at the same time. By forming the compensation layers and the internal electrodes by the same material at a time (for example, forming by a screen printing method or a metal film transfer method, etc.), production at low costs without increasing production processes can be attained.

Preferably, the compensation layers formed on the same plane as the internal electrodes are formed at positions corresponding to leads formed on other internal electrode to be stacked via the dielectric layer. When an internal electrode is formed on the ceramic green sheets composing the dielectric layer and the sheets are stacked and pressured in the case there is not a compensation layer, the lead of the internal electrode may deform as the green sheets collapses/sags. In the present invention, particularly, the compensation layer is formed between the sheets at positions corresponding to the leads, so breaks brought by the collapse and deformation of the leads can be efficiently prevented.

Preferably, a width of the compensation layer is approximately the same as a width of the lead.

Preferably, the compensation layer is connected to neither the internal electrodes nor the terminal electrodes. In the case where the compensation layer is comprised of a conductive layer as same as the internal electrode, when the compensation layer is connected to both of the internal electrode and the terminal electrode, a terminal electrode and an internal electrode which should not be connected are shorted which is not preferable.

Preferably, electrode patterns of the internal electrodes are divided to blocks of electrode patterns of every plurality of adjacent internal electrodes via the dielectric layers, and the electrode patterns of internal electrodes belonging to different blocks have an electrode pattern of a same shape but rotational positions at an axis vertical to a plane of the electrode pattern as a central axis are different.

As a result, at the time of turning on electricity to the multilayer ceramic electronic device, the plurality of internal electrodes of each of the blocks connected to an external circuit via a lead become electrodes of capacitors arranged in parallel facing to each other.

Also, since the leads are led out from the internal electrodes toward the side faces of the capacitor body, positive and negative currents are supplied in opposite directions to the nearby leads to cancel the magnetic fluxes. Therefore, the parasitic inductance of the multilayer electronic device itself can be reduced and the equivalent series inductance is reduced.

On the other hand, by having just a single lead be led out from the portion of the internal electrode giving the electrostatic capacity and connected to a terminal electrode, it is possible to supply the current to be concentrated to this single lead and to increase the electrical resistance at the lead. As a result of the increase in the electrical resistance at the lead in this way, even if an equivalent series inductance (ESL) reduction technology is adopted for supplying positive and negative currents in opposite directions between the nearby leads and canceling out the magnetic fluxes is adopted, the equivalent series resistance (ESR) can be prevented from becoming overly small.

Furthermore, by stacking a plurality of blocks of the same repeating electrode pattern structure changed only in a rotational position, there is no longer a need to fabricate internal electrodes with different lead patterns to match the number of internal electrodes, so that the production process is simplified and the manufacturing costs reduced.

Furthermore, it is also possible to incorporate a plurality of capacitors into a single multilayer electronic device. Therefore, by reducing the number of multilayer electronic devices to be mounted in an electrical product, the manufacturing costs can be reduced and, along with the increased integration of circuits, the required space can be reduced.

Preferably, the capacitor body is shaped as a hexahedron and the plurality of terminal electrodes are arranged at each of at least two side faces among the four side faces of the hexahedral ceramic body.

In this case, the ceramic body is formed to be a hexahedral shape which is the easiest to produce as a multilayer ceramic electronic device, thus, the production becomes easy. Also, since a plurality of terminal electrodes are respectively provided to at least two side faces among four side faces of the hexahedral shape ceramic body, when a high frequency current is flown to the terminal electrodes so that the respective terminal electrodes of the side faces become alternately positive and negative, positive and negative currents flow in the mutually opposite directions in adjacent leads. Therefore, an effect of cancelling out the magnetic flux intensively arises on these sides and an equivalent series inductance is furthermore reduced.

Preferably, adjacent terminal electrodes on an identical side face provided with the plurality of terminal electrodes are connected to different internal electrodes from each other.

In this case, as a result that currents flow so that polarities of adjacent terminal electrodes become mutually different, the magnetic fluxes generated at the leads cancel out to each other by the currents flowing in mutually opposite directions in the leads. Therefore, the effect of reduction of the ESL appears even more reliably.

### BRIEF DESCRIPTION OF THE DRAWINGS

These and other objects and features of the present invention will be explained in further detail with reference to the attached drawings, in which:

FIG. 1 is a sectional view of a multiterminal multilayer capacitor according to a first embodiment of the present invention taken along the line I-I of FIG. 3;

FIG. 2 is a sectional view of the multiterminal multilayer capacitor according to the first embodiment of the present invention taken along the line II-II of FIG. 3;

FIG. 3 is a perspective view of the multiterminal multilayer capacitor according to the first embodiment of the present invention;

FIG. 4 is a disassembled perspective view of a plurality of ceramic green sheets and electrode shapes used in the process of production of the multiterminal multilayer capacitor of the first embodiment;

FIG. 5A is a schematic view of a model of equivalent serial resistance showing a model of the equivalent serial resistance of a conventional capacitor;

FIG. 5B is a schematic view of a model of equivalent serial resistance showing a model of the equivalent serial resistance of a multiterminal multilayer capacitor of an embodiment;

FIG. 6A is a graph of the relationship between current and voltage in a model of a power supply circuit of an LSI showing the relationship of current and voltage of a conventional capacitor;

FIG. 6B is a graph of the relationship between current and voltage in a model of a power supply circuit of an LSI showing the relationship of current and voltage of a multiterminal multilayer capacitor of an embodiment;

FIG. 7 is a view of the state of use of the multiterminal multilayer capacitor;

FIG. 8 is a plan view of a ceramic green sheet having internal electrodes shown in FIG. 4;

FIG. 9 is a plan view of a pattern of a group of internal electrodes used in multiterminal multilayer capacitor of the related art;

FIG. 10 is a plan view of a pattern of another group of internal electrodes used in multiterminal multilayer capacitor of the related art.

### DESCRIPTION OF THE PREFERRED EMBODIMENTS

The multilayer electronic device of embodiments of the present invention will be described below with reference to the drawings.

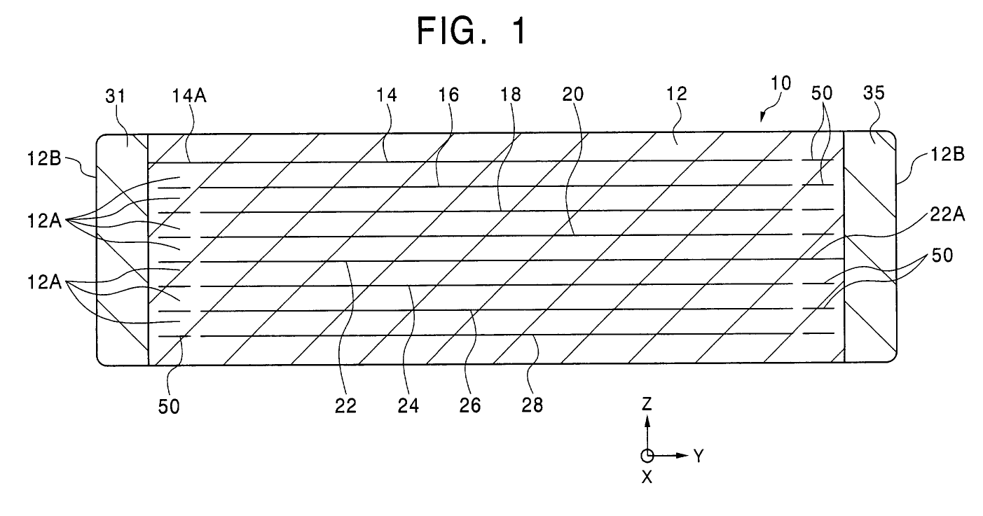

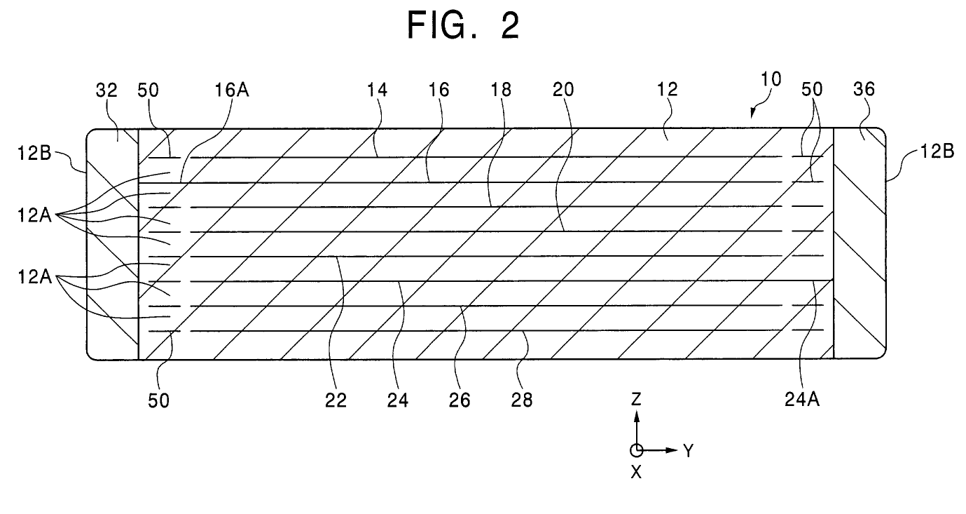

A multilayer ceramic electronic device according to an embodiment of the present invention, that is, an array type multiterminal multilayer capacitor 10, is shown in FIG. 1 to FIG. 4.

As shown in these figures, the multiterminal multilayer capacitor 10 is comprised of a main portion consisting of a rectangular parallelepiped sintered body obtained by stacking a plurality of ceramic green sheets for use as dielectric layers and firing the stack, that is, a capacitor body (ceramic body) 12.

A planar first internal electrode 14 is arranged at a position of a predetermined height (a predetermined position of the stacking direction Z) position in the capacitor body 12. A similar planar second internal electrode 16 is arranged below the first internal electrode 14 separated by the ceramic layer (dielectric layer) 12A in the capacitor body 12.

A planar third internal electrode 18 is arranged below the second internal electrode 16 separated by the ceramic layer 12A in the capacitor body 12. A planar fourth internal electrode 20 is arranged below the third internal electrode 18 separated by the ceramic layer 12A in the capacitor body 12.

Further, a planar fifth internal electrode 22 is arranged below the fourth internal electrode 20 separated by the ceramic layer 12A in the capacitor body 12. A planar sixth internal electrode 24 is arranged below the fifth internal electrode 22 separated by the ceramic layer 12A in the capacitor body 12.

A planar seventh internal electrode 26 is arranged below the sixth internal electrode 24 separated by the ceramic layer 12A in the capacitor body 12. A planar eighth internal electrode 28 is arranged below the seventh internal electrode 26 separated by the ceramic layer 12A in the capacitor body 12.

Therefore, the first internal electrode 14 to the eighth internal electrode 28 are arranged facing each other separated by ceramic layers 12A in the capacitor body 12. The center of these first internal electrode 14 to eighth internal electrode 28 is arranged to be at substantially the same position as the center of the capacitor body 12. Further, the longitudinal and lateral dimensions of the first internal electrode 14 to the eighth internal electrode 28 are made smaller than the lengths of the corresponding sides of the capacitor body 12.

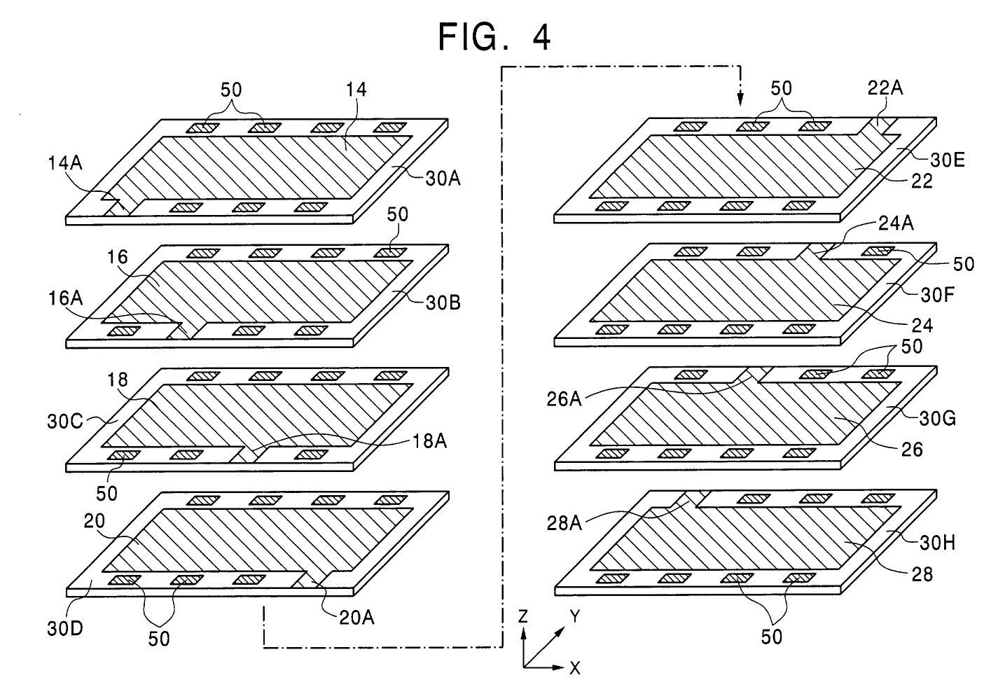

Further, as shown in FIG. 4, by leading out one electrode from a position near the left end in the longitudinal direction X of a side on the illustrated front side of the width direction Y of the first internal electrode 14 toward the illustrated upper front, one lead 14A is formed at the first internal electrode 14. Further, by leading out one electrode from a second position from the left end of a side on the illustrated front side of the second internal electrode 16 toward the front side, one lead 16A is formed at the second internal electrode 16.

On the other hand, by leading out one electrode from the third position from the left end of a side on the front side of the third internal electrode 18 toward the front side, one lead 18A is formed at the third internal electrode 18. Further, by leading out one electrode from a position near the right end of a side on the front side of the fourth internal electrode 20 toward the front side, one lead 20A is formed at the fourth internal electrode 20.

Also, by leading out one electrode from a position near the right end of the longitudinal direction X of a side on the rear side of the width direction Y of the fifth internal electrode 22 toward the illustrated upper rear side, one lead 22A is formed at the fifth internal electrode 22. Further, by leading out one electrode from the second position from the right end of a side on the rear side of the sixth internal electrode 24 toward the illustrated upper rear side, one lead 24A is formed at the sixth internal electrode 24.

On the other hand, by leading out one electrode from the third position from the right end of a side on the rear side of the seventh internal electrode 26 toward the illustrated upper rear side, one lead 26A is formed at the seventh internal electrode 26. Further, by leading out one electrode from a position near the left end of a side on the rear side of the eighth internal electrode 28 toward the illustrated upper rear side, one lead 28A is formed at the eighth internal electrode 28.

Due to the above, a total of eight leads from the leads 14A to 28A are respectively led out from the internal electrodes 14 to 28 at non-overlapping positions to both sides of the width direction Y.

Further, in the same way as in a conventional multiterminal multilayer capacitor with terminal electrodes arranged at the side faces, as shown from FIG. 1 to FIG. 3, the first terminal electrode 31 connected to the lead 14A of the internal electrode 14, the second terminal electrode 32 connected to the lead 16A of the internal electrode 16, the third terminal electrode 33 connected to the lead 18A of the internal electrode 18, and the fourth terminal electrode 34 connected to the lead 20A of the internal electrode 20 are arranged at the left side face 12B of the capacitor body 12.

That is, the lead 14A of the first internal electrode 14 to the lead 20A of the fourth internal electrode 20 are positioned on sides on the front side of these internal electrodes as shown in FIG. 4 without overlapping. Therefore, the terminal electrodes 31 to 34 are arranged at the left side face 12B of the capacitor body 12 in a manner with adjoining terminal electrodes successively connected at different internal electrodes 14 to 20 through the leads 14A to 20A as shown in FIG. 1 to FIG. 3. As a result, for example the adjoining terminal electrodes can be used at opposite polarities to each other.

Further, in the same way, the fifth terminal electrode 35 connected to the lead 22A of the internal electrode 22, the sixth terminal electrode 36 connected to the lead 24A of the internal electrode 24, the seventh terminal electrode 37 connected to the lead 26A of the internal electrode 26, and the eighth terminal electrode 38 connected to the lead 28A of the internal electrode 28 are arranged at the right side face 12B of the capacitor body 12.

That is, the lead 22A of the fifth internal electrode 22 to the lead 28A of the eighth internal electrode 20 are positioned on sides on the rear side of the internal electrodes as shown in FIG. 4 without overlapping. Therefore, the terminal electrodes 35 to 38 are arranged at the right side face 12B of the capacitor body 12 in a manner with adjoining terminal electrodes successively connected at different internal electrodes 22 to 28 through the leads 22A to 28A as shown in FIG. 1 to FIG. 3. As a result, for example the adjoining terminal electrodes can be used at opposite polarities.

Due to the above, in the present embodiment, as shown in FIG. 1 to FIG. 3, by having the terminal electrodes 31 to 34 arranged at the left side face 12B of the multiterminal multilayer capacitor 10 and having the terminal electrodes 35 to 38 arranged at the right side face 12B. Therefore, the terminal electrodes 31 to 38 are arranged at the two side faces 12B among the four side faces 12B and 12C of the capacitor body 12 made the rectangular parallelopiped, that is, the hexahedral shape.

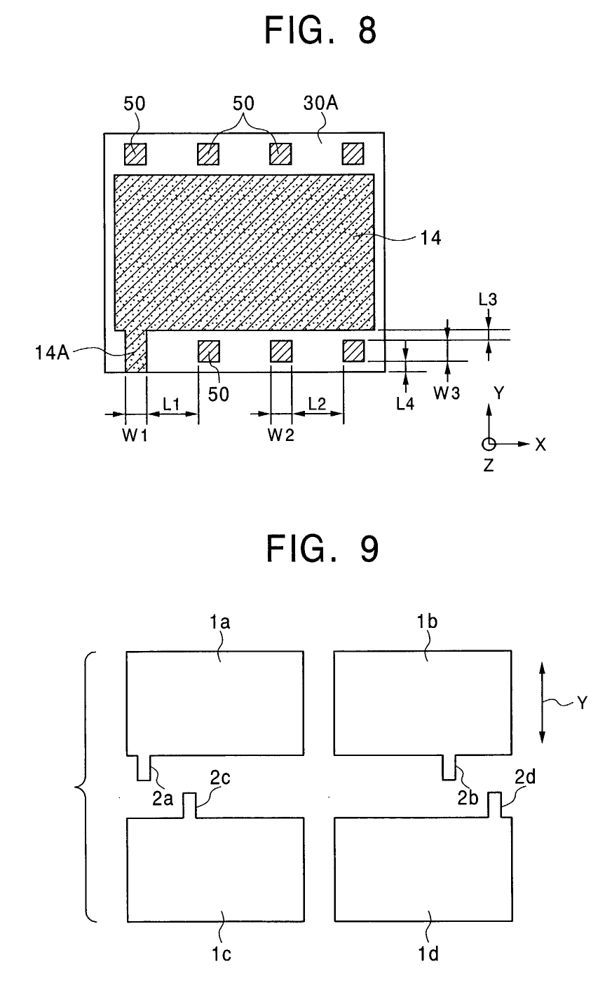

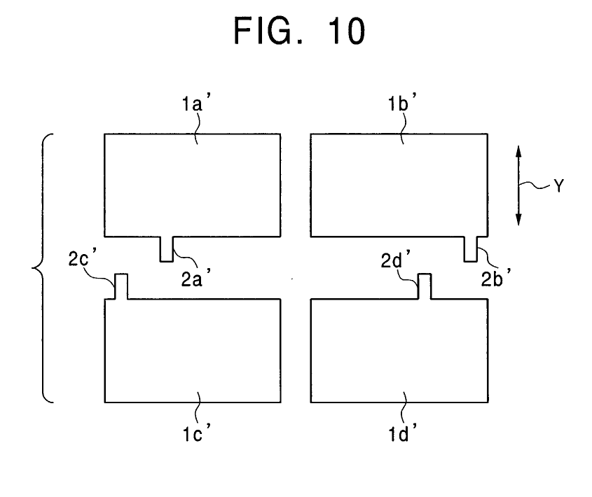

Furthermore, in the present embodiment, as shown in FIG. 4 and FIG. 8, compensation layers 50 are formed on the same plane as the internal electrodes 14 to 28 to have the same thickness as that of the internal electrodes in a pattern connected to neither of the internal electrodes and the terminal electrodes, furthermore, the patterns are mutually separated. Positions the compensation layers 50 are formed are positions corresponding to leads formed on other internal electrodes to be stacked via the green sheets 30A to 30H to be a dielectric layer.

The respective compensation layers 50 are formed to be a rectangular shape in the present embodiment. It may be a circular shape, elliptical shape, or other shape, but a rectangular shape corresponding to a shape of the lead is preferable.

As shown in FIG. 8, a width W2 of the compensation layers 50 is approximately the same as the width W1 in the X direction, and preferably 80 to 300 μm. The width W1 of the lead 14A is about the same as or narrower than the width of the terminal electrode 31 connected to the lead 14A, but electric resistance tends to increase when it is too narrow.

Also, a width W3 in the Y direction of the compensation layer 50 is not particularly limited and determined so that a distance L3 capable of insulating from the internal electrode 14 is secured. Alternately, it is determined so that a distance L4 capable of insulating from the terminal electrodes 32 to 38 not connected to the internal electrode 14 is secured. Note that the distance L3 or L4 by which insulation is kept is preferably 50 to 300 μm.

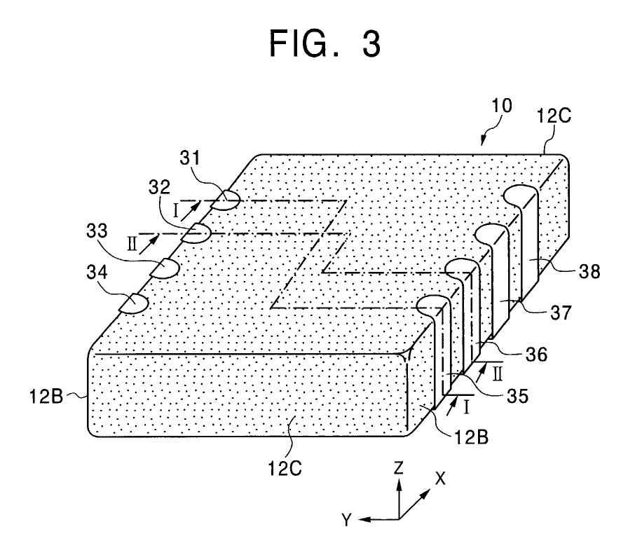

A distance L1 to the lead 14A from the nearest compensation layer 50 to that is determined so that insulation between the two is kept and an adhesion area between green sheets (for example between 30A and 30B) to be stacked in the stacking direction Z is sufficiently secured. The distance L1 is substantially the same as the distance L2 between compensation layers 50 and is preferably about 1 to 3 times as long as the width W2. Note that the distance L1 or L2 is equivalent to or less than a space between the terminal electrodes (for example a space between 31 and 32) shown in FIG. 3. The compensation layers 50 are composed of the same material as that of the internal electrode on the same plane and formed at the same time to have same thickness.

Note that the above explanation was made on a size and positional relationship of the compensation layer 50 positioned on the same plane as the internal electrode 14 by referring to FIG. 8, but the same explanation can be applied to those of a compensation layer 50 positioned on the same plane as other internal electrode.

Next, production of a multiterminal multilayer capacitor 10 according to the present embodiment will be explained based on FIG. 4.

First, for producing the multiterminal multilayer capacitor 10, a plurality of ceramic green sheets 30A, 30B, 30C, 30D, 30E, 30F, 30G and 30H comprised of a dielectric material which function as capacitors are prepared.

As shown in FIG. 4, to form the internal electrodes 14, 16, 18 and 20 each having one of leads 14A, 16A, 18A and 20A and the compensation layers 50, an electrode pattern is formed on each of the upper surfaces of the ceramic green sheets 30A, 30B, 30C and 30D.

In the same way, to form the internal electrodes 22, 24, 26 and 28 each having one of leads 22A, 24A, 26A and 28A and the compensation layers 50, an electrode pattern is formed on each of the upper surfaces of the ceramic green sheets 30E, 30F, 30G and 30H.

Note that the electrode pattern arranged on the upper surface of the ceramic green sheets 30A to 30H is provided for example by printing or depositing a conductive paste. The sheet thickness, etc. may be changed in accordance with required properties between the ceramic green sheets 30A to 30D and the ceramic green sheets 30E to 30H.

Then, the ceramic green sheets 30A to 30H each having a rectangular shaped plane are stacked in the order shown in FIG. 4, a protective green sheet on which internal electrodes and compensation layers are not formed is stacked on the top and the bottom in the stacking direction Z, and the stacked body is pressured to form a preparatory molding. After firing the preparatory molding as a unit, terminal electrodes 31 to 38 are formed. Note that the terminal electrodes 31 to 38 may be fired as one unit after being formed on the preparatory molding.

As a result, a first terminal electrode 31 is connected to the lead 14A of the internal electrode 14, a second terminal electrode 32 is connected to the lead 16A of the internal electrode 16, a third terminal electrode 33 is connected to the lead 18A of the internal electrode 18, a fourth terminal electrode 34 is connected to the lead 20A of the internal electrode 20, a fifth terminal electrode 35 is connected to the lead 22A of the internal electrode 22, a sixth terminal electrode 36 is connected to the lead 24A of the internal electrode 24, a seventh terminal electrode 37 is connected to the lead 26A of the internal electrode 26, and a eighth terminal electrode 38 is connected to the lead 28A of the internal electrode 28. The compensation layers 50 are formed between the terminal electrode and the internal electrode without connecting to them on the same plane as the internal electrode, respectively.

As a result, a multiterminal multilayer capacitor 10 wherein terminal electrodes 31 to 34 are provided on a side face 12B on the left in four side faces 12B and 12C of the capacitor body 12, and terminal electrodes 35 to 38 are provided on a side face 12B on the right side can be obtained.

Next, an effect of the multiterminal multilayer capacitor 10 according to the present embodiment will be explained.

Eight internal electrodes 14 to 28 are arranged being separated by ceramic layers 12A in the capacitor body 12 formed by stacking dielectric layers of ceramic, etc. The eight internal electrodes 14 to 28 have the leads 14A to 28A respectively led out toward the facing two side faces 12B of the capacitor body 12, and a total of eight terminal electrodes 31 to 38 are arranged outside the capacitor 12.

Among the leads 14A to 28A, the first terminal electrode 31 is connected to the internal electrode 14 via the lead 14A, the second terminal electrode 32 is connected to the internal electrode 16 via the lead 16A, the third terminal electrode 33 is connected to the internal electrode 18 via the lead 18A, and the fourth terminal electrode 34 is connected to the internal electrode 20 via the lead 20A.

The internal electrodes 14, 16, 18 and 20 and the terminal electrodes 31, 32, 33 and 34 compose one capacitor. At the time of turning on electricity to the capacitor, the terminal electrodes 31 to 34 become alternately a positive electrode and a negative electrode, and the four internal electrodes 14 to 20 connected to the terminal electrodes 31 to 34 via the leads 14A to 20A become electrodes of the capacitor which face to each other and are arranged in parallel.

Also, the fifth terminal electrode 35 is connected to the internal electrode 22 via the lead 22A, the sixth terminal electrode 36 is connected to the internal electrode 24 via the lead 24A, the seventh terminal electrode 37 is connected to the internal electrode 26 via the lead 26A, and the eighth terminal electrode 38 is connected to the internal electrode 28 via the lead 28A.

The internal electrodes 22, 24, 26 and 28 and the terminal electrodes 35, 36, 37 and 38 compose another capacitor. At the time of turning on electricity to the capacitor, the terminal electrodes 35 to 38 become alternately a positive electrode and a negative electrode, and the four internal electrodes 22 to 28 connected to the terminal electrodes 35 to 38 via the leads 22A to 28A become electrodes of the capacitor which face to each other and are arranged in parallel.

Furthermore, in the present embodiment, the capacitor body 12 is formed in a hexahedral shape, four terminal electrodes 31 to 38 are respectively arranged at the two side faces 12B among the four side faces 12B and 12C of the hexahedral capacitor body 12, these terminal electrodes 31 to 34 arranged on the same side face 12B are connected to the successively different internal electrodes 14 to 20, and the terminals electrodes 35 to 38 arranged on the same side face 12B in the same way are connected to successively different internal electrodes 22 to 28.

Therefore, in the multiterminal multilayer capacitor 10 of this structure, when high frequency currents alternating in polarity are respectively flown to the terminal electrodes 31 to 34 and terminal electrodes 35 to 38 so that polarities of the adjoining terminal electrodes among the terminal electrodes 31 to 34 and terminal electrodes 35 to 38 become different, the currents flow in opposite directions in adjoining leads, so the effect of cancellation of the magnetic fluxes arises concentratedly on these side faces 12B and the equivalent series inductance is reduced.

On the other hand, by providing single leads 14A to 28A connected to the terminal electrodes 31 to 38 led out from the internal electrodes 14 to 28 parts giving an electrostatic capacity, the currents flow concentratedly at the single leads and the electrical resistance at the leads 14A to 28A can be increased. Further, as a result of the increase of the electrical resistance at the leads 14A to 28A in this way, even if the ESL reduction technology is employed for supplying positive and negative currents in opposite directions between adjoining leads to cancel out the magnetic fluxes, the ESR can be prevented from becoming excessively small.

Further, in the present embodiment, since two capacitors are substantially included in a single multiterminal multilayer capacitor 10 in the above way, by reducing the number of multiterminal multilayer capacitor 10, the manufacturing costs are reduced and the space taken up can be reduced as required along with the increasing integration of circuits.

Next, results of tests conducted to compare the equivalent series inductance and equivalent series resistance between the multiterminal multilayer capacitor 10 according to the present embodiment and another capacitor will be shown. Further, the other capacitor compared with here is a multiterminal multilayer capacitor reduced in ESL by being provided with four leads for one internal electrode and has the same eight internal electrodes as the multi~terminal multilayer capacitor 10 of the present embodiment. Further, the electrostatic capacity used in the tests is 1 μF.

As a result of the tests, the equivalent series inductance of the conventional reduced ESL multiterminal multilayer capacitor was found to be 126 pH and the equivalent series resistance was found to be 2.4 mΩ. As opposed to this, the equivalent series inductance of the multiterminal multilayer capacitor 10 according to the present embodiment was found to be 123 pH and the ESR was found to be 9.8 mΩ.

That is, while the equivalent series inductances were substantially the same to each other, the equivalent series resistance of the multiterminal multilayer capacitor 10 of the present embodiment became about four times larger than the conventional multiterminal multilayer capacitor.

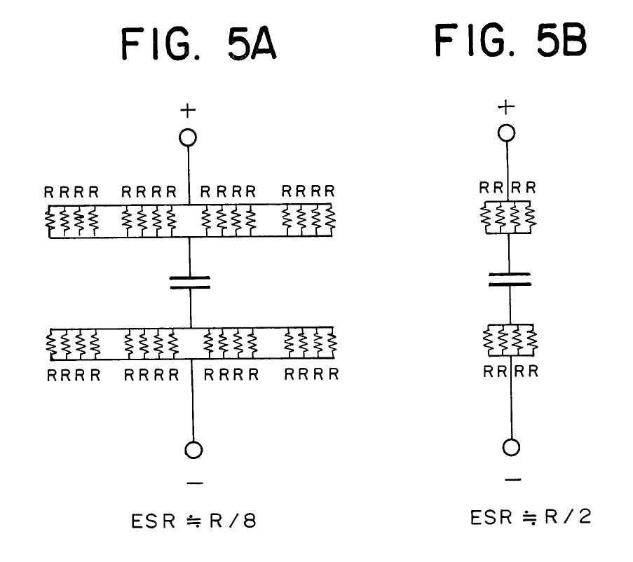

This is believed to be because while the equivalent series resistance of the conventional capacitor was about R/8 from the model of the equivalent series resistance shown in FIG. 5A, the equivalent series resistance of the multiterminal multilayer capacitor 10 of the present embodiment was about R/2 from the model of the equivalent series resistance shown in FIG. 5B. Further, in FIG. 5A and FIG. 5B, “R” indicates the electrical resistance at the leads.

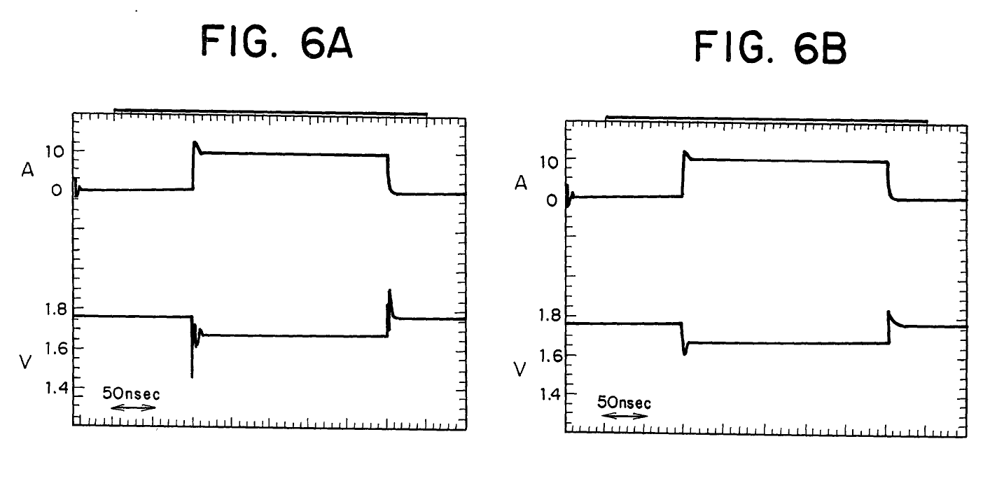

Further, a comparison of the voltage fluctuations of the power supply circuit accompanying sharp current fluctuations is shown in FIG. 6A and FIG. 6B. That is, while the conventional capacitor shown in FIG. 6A suffered from a large voltage fluctuation, the multiterminal multilayer capacitor 10 of the present embodiment shown in FIG. 6B had a far smaller voltage fluctuation as a result of the larger equivalent series resistance and the power supply circuit was stabilized.

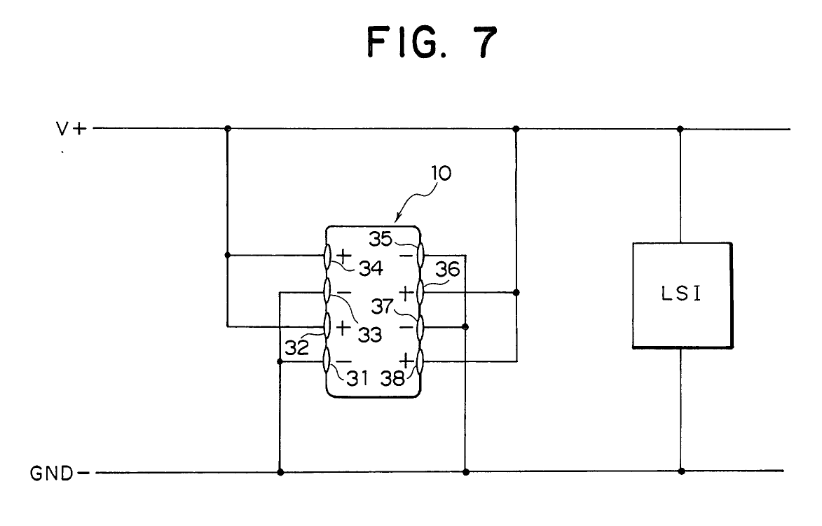

Next, an example of use of the multiterminal multilayer capacitor 10 according to the present embodiment will be explained based on FIG. 7.

As shown in FIG. 7, the multiterminal multilayer capacitor 10 of the present embodiment is arranged in parallel with the LSI chip between the ground terminal GND and a terminal “V” having a predetermined potential. The terminal electrodes 31 to 34 positioned on the left side in the figure of the multiterminal multilayer capacitor 10 and the internal electrodes 14 to 20 connected to the terminal electrodes 31 to 34 constitute one capacitor, while the terminal electrodes 35 to 38 positioned on the right side in the figure of the multiterminal multilayer capacitor 10 and the internal electrodes 22 to 28 connected to the terminal electrodes 35 to 38 constitute another capacitor, so two capacitors are substantially connected in parallel with the LSI chip.

Furthermore, by making the capacitances of the two capacitors formed in the capacitor of the present embodiment different to each other in accordance with a use, one can be a capacitor for high frequencies the other can be a capacitor for low frequencies.

Particularly, compensation layers 50 are formed between the internal electrodes 14 to 28 on which the leads 14A to 28A are not formed and the terminal electrodes 31 to 38 in the present embodiment. Therefore, in pressure adhering processing performed after stacking the green sheets 30A to 30H (portions to be a dielectric layer 12A), it is possible to efficiently prevent the dielectric layer 12A of the body 10 from collapsing/sagging in the stacking direction Z (reducing in the thickness comparing with other portions) on the side face 12B of the body 10 being formed the leads 14A to 28A of the internal electrodes 14 to 28. Namely, in the multiterminal multilayer ceramic capacitor of the present embodiment, the thicknesses on both sides and at the center of the body 10 become equal.

Also, since the compensation layers 50 are separated from each other on the same plane, the dielectric layers 12A sandwiching the internal electrodes 14 to 28 adhere firmly to each other and the adhesion area between the dielectric layers 12A can be sufficiently secured. As a result, cracks and gaps can be suppressed on the dielectric layers 12A and breaks of the leads 14A to 28A (lead electrodes) can be prevented. Furthermore, an occurrence of structural defaults due to bad adhesion of the dielectric layers can be prevented and the productivity yield can be improved.

When a view of a cross-sectional picture of the capacitor body was obserbed, it was confirmed that an occurrence of collapse/sags, cracks and gaps on the dielectric layers 12A can be prevented and that breaks of leads (lead electrodes) can be prevented.

Also, in the present embodiment, the compensation layers 50 are constituted by the same material as that of the internal electrodes 14 to 28 and formed at the same time. By forming the compensation layers 50 and the internal electrodes 14 to 28 by the same material at a time (for example, forming by a screen printing method or a metal film transfer method, etc.), production at low costs without increasing production processes can be attained.

Furthermore, in the present embodiment, the compensation layers 50 formed on the same plane as internal electrodes 14 to 28 are formed at positions corresponding to the leads 14A to 28A formed on other internal electrodes to be stacked via the dielectric layers 12A. When forming the internal electrodes 14 to 28 on the ceramic green sheets 30A to 30H constituting the dielectric layers 12A, stacking and pressuring these sheets in the case there is no compensation layers 50, the leads 14A to 28A of the internal electrodes are liable to deform as of the green sheets 30A to 30H collapse/sag. In the present embodiment, particularly, as a result that the compensation layers 50 are formed between the sheets at the positions corresponding to the leads 14A to 28A, breaks due to collapse/sag deformation of the leads 14A to 28A can be efficiently prevented.

Furthermore, the width W1 of the compensation layers 50 is approximately the same as the width W2 of the leads 14A to 28A. It is particularly preferable in terms of efficiently preventing breaks caused by collapse/sag deformation of the leads 14A to 28A.

Note that the present invention is not limited to the above embodiments and a variety of modifications can be made within the scope of the present invention.

For example, the above embodiments were explained based on an 8-terminal multilayer ceramic capacitor wherein leads 14A to 28A as lead electrodes are lead out in the width direction Y of the body 10, but the multiterminal multilayer ceramic electronic device of the present invention is not limited to this. For example, it can be applied to a three-dimensional installation multiterminal multilayer ceramic capacitor, etc. wherein leads are led to each portion of four sides. Furthermore, the multiterminal multilayer ceramic electronic device of the present invention is not limited to multilayer ceramic capacitors and may be applied to other multiterminal multilayer ceramic electronic devices.

1. A multiterminal multilayer ceramic electronic device comprising:
a ceramic body formed by stacking dielectric layers;
a plurality of internal electrodes separated by dielectric layers inside said ceramic body, each having at least one lead led out toward any side face of said ceramic body, and differing in position of arrangement of said lead with the nearby internal electrodes; and
a plurality of terminal electrodes arranged at the outside surface of the ceramic body and connected to any of the plurality of the internal electrodes through the leads; and
a compensation layer formed between said internal electrodes from which said leads are not formed and said terminal electrodes, having approximately the same thickness as that of said internal electrodes, not connected to at least one of said internal electrodes and said terminal electrodes, and separated from each other on the same plane.

2. The multiterminal multilayer ceramic electronic device as set forth in claim 1, wherein said compensation layer is comprised of the same material as that of said internal electrodes and formed at the same time.

3. The multiterminal multilayer ceramic electronic device as set forth in claim 1 or 2, wherein the compensation layers formed on the same plane as said internal electrodes are formed at positions corresponding to leads formed on other internal electrode, to be stacked via said dielectric layer.

4. The multiterminal multilayer ceramic electronic device as set forth in claim 3, wherein a width of said compensation layer is approximately the same as a width of said lead.

5. The multiterminal multilayer ceramic electronic device as set forth in claim 4, wherein said compensation layer is connected to neither said internal electrodes nor said terminal electrodes.

6. The multiterminal multilayer ceramic electronic device as set forth in claim 1, wherein electrode patterns of said internal electrodes are divided to blocks of electrode patterns of every plurality of adjacent internal electrodes via said dielectric layers, and the electrode patterns of internal electrodes belonging to different blocks have an electrode pattern of a same shape but rotational positions at an axis vertical to a plane of the electrode pattern as a central axis are different.

7. The multiterminal multilayer ceramic electronic device as set forth in claim 6, wherein said ceramic body is formed to be,a hexahedral shape and a plurality of terminal electrodes are respectively arranged on at least two side faces of four side faces of the hexahedral shaped ceramic body.

8. The multiterminal multilayer ceramic electronic device as set forth in claim 7, wherein adjacent terminal electrodes on an identical side face provided with said plurality of terminal electrodes are connected to different internal electrodes from each other.
